(19) United States
(12) Patent Application Publication
(10) Pub. No.: US 2026/0160215 A1
(43) Pub. Date: Jun. 11, 2026

(54) CONTROLLER FOR INTERNAL COMBUSTION ENGINE

(71) Applicant: TOYOTA JIDOSHA KABUSHIKI KAISHA, Toyota-shi (JP)

(72) Inventor: Tatsunobu HATTORI, Seto-shi (JP)

(21) Appl. No.: 19/178,918

(22) Filed: Apr. 15, 2025

(30) Foreign Application Priority Data
Jun. 4, 2024 (JP) 2024-090702

(51) Int. Cl. F02D 41/22

(52) U.S. Cl. CPC F02D 41/221; F02D 2041/224; F02D 2200/0602

(57) ABSTRACT

A controller for an internal combustion engine is provided. Control circuitry executes a determination process when the internal combustion engine is in an idling operation state. A pressure sensor detects a passage fuel pressure that is a pressure of gaseous fuel in a portion of a fuel passage between a shut-off valve and a fuel injection valve. The determination process determines whether the shut-off valve is stuck open based on an output of a valve closing signal to the shut-off valve and a decrease amount of the passage fuel pressure that occurs until an elapsed period after the valve closing signal is output reaches a predetermined specified period.

### CROSS-REFERENCE TO RELATED APPLICATIONS

This application is based upon and claims the benefit of priority from Japanese Patent Application No. 2024-090702, filed on Jun. 4, 2024, the entire contents of which are incorporated herein by reference.

### BACKGROUND

### 1. Field

The present disclosure relates to a controller for an internal combustion engine.

### 2. Description of Related Art

Internal combustion engines using gaseous fuel are known. Some internal combustion engines include a fuel passage in which a shut-off valve is disposed. The shut-off valve closes while the internal combustion engine is not in operation, thereby stopping the fuel supply from the fuel tank to the fuel injection valves. Japanese Laid-Open Patent Publication No. 2001-041106 discloses a vehicle equipped with such an internal combustion engine.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a controller for an internal combustion engine includes control circuitry. The control circuitry is configured to execute a determination process when the internal combustion engine is in an idling operation state. The internal combustion engine is mounted on a vehicle. The internal combustion engine includes a fuel tank storing gaseous fuel, a fuel injection valve supplying the gaseous fuel into a cylinder, a fuel passage connecting the fuel tank to the fuel injection valve, a shut-off valve disposed in the fuel passage, and a pressure sensor disposed in a portion of the fuel passage between the shut-off valve and the fuel injection valve. The pressure sensor detects a passage fuel pressure that is a pressure of the gaseous fuel in a portion of the fuel passage between the shut-off valve and the fuel injection valve. The determination process determines whether the shut-off valve is stuck open based on an output of a valve closing signal to the shut-off valve and a decrease amount of the passage fuel pressure that occurs until an elapsed period after the valve closing signal is output reaches a predetermined specified period.

The above-described controller for an internal combustion engine is capable of executing the determination process when the influence on the traveling of the vehicle is small.

According to another aspect of the present disclosure, an internal combustion engine having similar features is provided.

The shut-off valve being stuck open can be determined based on a change in the passage fuel pressure after the valve closing command is output to the shut-off valve during the execution of fuel injection. The passage fuel pressure can represent the pressure of the fuel between the shut-off valve and the fuel injection valve in the fuel passage. If the shut-off valve is closed, the amount of fuel in the fuel passage decreases as the fuel injection is performed, and thus the passage fuel pressure decreases. If the shut-off valve is stuck open, fuel continues to be supplied from the fuel tank to the fuel injection valve. Accordingly, if fuel injection is executed, the passage fuel pressure is unlikely to decrease. Therefore, it is possible to determine that the shut-off valve is stuck open based on a small amount of decrease in the passage fuel pressure.

Since the stuck valve determination process for the shut-off valve is accompanied by a valve closing operation of the shut-off valve, the fuel supplied to the internal combustion engine is limited. When the fuel supplied to the internal combustion engine is limited, the traveling of the vehicle may be affected. The above-described configuration suppresses this potential issue.

Other features and aspects will be apparent from the following detailed description, the drawings, and the claims.

### BRIEF DESCRIPTION OF THE DRAWINGS

FIG. 1 is a schematic diagram showing an internal combustion engine and a controller for the internal combustion engine according to an embodiment.

FIG. 2 is a flowchart showing a procedure of a stuck valve determination process executed by the controller of the embodiment shown in FIG. 1.

FIGS. 3A to 3J are timing diagrams showing transitions of states at the time of execution of the stuck valve determination process shown in FIG. 2, in the internal combustion engine in which the controller of the embodiment shown in FIG. 1 is employed, where FIG. 3A shows an accelerator operation amount, FIG. 3B shows an engine rotation speed, FIG. 3C shows a vehicle speed, FIG. 3D shows a state of an ignition switch, FIG. 3E shows a state of an idling determination, FIG. 3F shows a stopped-state determination, FIG. 3G shows a state of a precondition, FIG. 3H shows a state of a shut-off valve, FIG. 3I shows a state of a passage fuel pressure, and FIG. 3J shows a state of determination.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

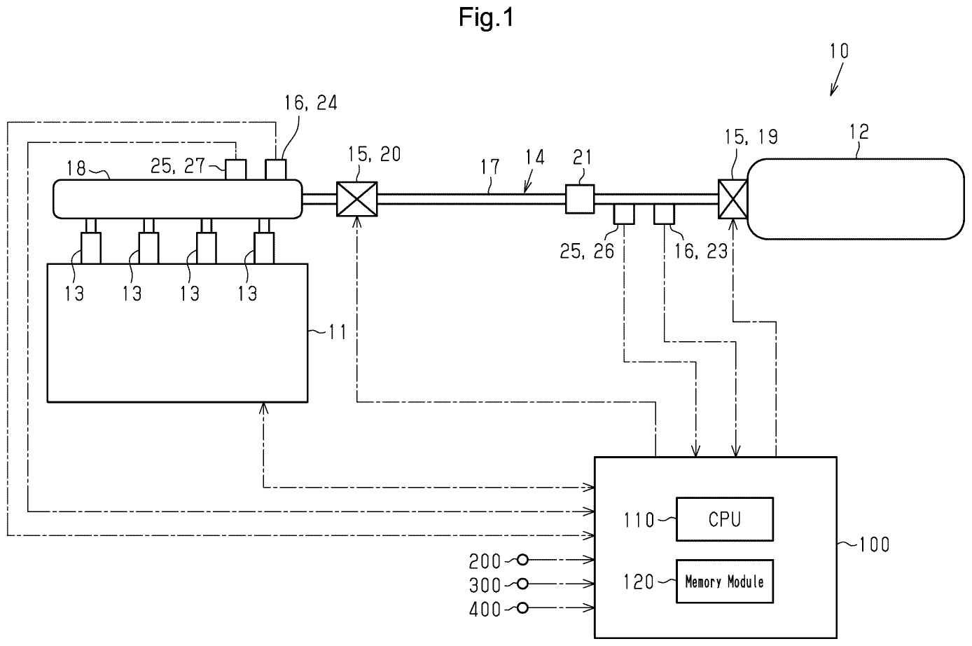

FIGS. 1 to 3J illustrate a controller for an internal combustion engine according to an embodiment.

### Configuration of Internal Combustion Engine and Controller for Internal Combustion Engine

FIG. 1 shows an internal combustion engine 10 mounted on a vehicle. The fuel of the internal combustion engine 10 is gaseous fuel. An example of a gaseous fuel is hydrogen gas.

The internal combustion engine 10 includes an engine body 11. The engine body 11 burns the fuel injected from the fuel injection valve 13 inside each cylinder to generate power for making the vehicle travel. In FIG. 1, a cylinder, an ignition plug, and the like are omitted.

The internal combustion engine 10 includes a fuel tank 12, fuel injection valves 13, a fuel passage 14, one or more shut-off valves 15, and one or more pressure sensors 16. The fuel tank 12 stores a gaseous fuel. In the fuel tank 12, gaseous fuel is stored in a compressed state. Gaseous fuel is supplied from the fuel tank 12 to the fuel injection valves 13. The fuel injection valves 13 supply fuel into the cylinders.

The fuel passage 14 connects the fuel tank 12 to the fuel injection valves 13. The fuel passage 14 includes a fuel pipe 17 connected to the fuel tank 12, and a delivery pipe 18 connecting the fuel pipe 17 to the fuel injection valves 13. The fuel stored in the fuel tank 12 is supplied to the fuel injection valves 13 via a fuel pipe 17 and a delivery pipe 18.

One or more shut-off valves 15 are disposed in the fuel passage 14. The one or more shut-off valves 15 are, for example, electromagnetic valves. The one or more shut-off valves 15 are switched between an open state and a closed state by the controller 100. The one or more shut-off valves 15 are opened when a valve opening command is received from the controller 100. The one or more shut-off valves 15 are closed when receiving a valve closing command from the controller 100. Specifically, when a valve opening command is input from the controller 100 to the drive circuit of the one or more shut-off valves 15, the drive circuit supplies electric power to the one or more shut-off valves 15. As a result, the one or more shut-off valves 15 are in an open state. On the other hand, when a valve closing command is input from the controller 100 to the drive circuit of the one or more shut-off valves 15, the drive circuit stops the supply of electric power to the one or more shut-off valves 15. As a result, the one or more shut-off valves 15 are in a closed state. The one or more shut-off valves 15 are kept open during operation of the internal combustion engine 10. The one or more shut-off valves 15 are maintained in a closed state while the internal combustion engine 10 is not driven. The shut-off valves 15 of the present embodiment include a first shut-off valve 19 and a second shut-off valve 20.

The first shut-off valve 19 is disposed in the fuel passage 14 in the vicinity of the outlet of the fuel tank 12. The first shut-off valve 19 is disposed at an end portion of the fuel pipe 17 on the fuel tank 12 side. When the first shut-off valve 19 is in an open state, fuel is supplied from the fuel tank 12 to the fuel pipe 17. When the first shut-off valve 19 is in the closed state, the supply of fuel from the fuel tank 12 to the fuel pipe 17 is stopped.

The second shut-off valve 20 is disposed downstream of the first shut-off valve 19 in the fuel passage 14. The second shut-off valve 20 is disposed in the vicinity of the delivery pipe 18. The second shut-off valve 20 is disposed between the fuel pipe 17 and the delivery pipe 18. When the second shut-off valve 20 is opened, fuel is supplied from the fuel pipe 17 to the delivery pipe 18. When the second shut-off valve 20 is in the closed state, the fuel supply from the fuel pipe 17 to the delivery pipe 18 is stopped.

A pressure reducing valve 21 is disposed in the fuel passage 14 between the first shut-off valve 19 and the second shut-off valve 20. The pressure reducing valve 21 regulates the pressure of the fuel flowing into the delivery pipe 18 from the high-pressure fuel tank 12.

The one or more pressure sensors 16 are disposed in a portion of the fuel passage 14 between the shut-off valves 15 and the fuel injection valves 13. One or more pressure sensors 16 detect the passage fuel pressure. Here, the passage fuel pressure is the pressure of the fuel in the portion between the shut-off valves 15 and the fuel injection valves 13. The one or more pressure sensors 16 output a detection signal related to the detected passage fuel pressure to the controller 100.

The pressure sensors 16 of the present embodiment include a first pressure sensor 23 and a second pressure sensor 24. The first pressure sensor 23 is arranged between the first shut-off valve 19 and the fuel injection valves 13 in the fuel passage 14. Further, the first pressure sensor 23 is arranged between the first shut-off valve 19 and the second shut-off valve 20 in the fuel passage 14. The first pressure sensor 23 detects a first passage fuel pressure. The first passage fuel pressure indicates a passage fuel pressure between the first shut-off valve 19 and the fuel injection valves 13. The second pressure sensor 24 is disposed between the second shut-off valve 20 and the fuel injection valves 13. The second pressure sensor 24 detects a second passage fuel pressure that indicates a passage fuel pressure between the second shut-off valve 20 and the fuel injection valves 13.

The internal combustion engine 10 is provided with one or more temperature sensors 25. The one or more temperature sensors 25 are arranged in a portion between the shut-off valves 15 and the fuel injection valves 13 in the fuel passage 14. The one or more temperature sensors 25 detect a passage fuel temperature which is a temperature of fuel in a portion between the shut-off valves 15 and the fuel injection valves 13. The one or more temperature sensors 25 output a detection signal regarding the detected passage fuel temperature to the controller 100.

The temperature sensors 25 of the present embodiment include a first temperature sensor 26 and a second temperature sensor 27. The first temperature sensor 26 is disposed between the first shut-off valve 19 and the fuel injection valves 13. The first temperature sensor 26 is disposed between the first shut-off valve 19 and the second shut-off valve 20. The second temperature sensor 27 is arranged between the second shut-off valve 20 and the fuel injection valves 13.

The controller 100 performs various controls of the internal combustion engine 10 by controlling various control targets such as the fuel injection valves 13, the first shut-off valve 19, the second shut-off valve 20, and the pressure reducing valve 21. For example, the controller 100 open the shut-off valves 15 by transmitting a valve opening signal to the shut-off valves 15. On the other hand, the controller 100 closes the shut-off valves 15 by transmitting a valve closing signal to the shut-off valves 15.

The controller 100 is control circuitry including a CPU 110 and a memory module 120 including a ROM, a RAM, and the like. When the CPU 110 executes the program stored in the memory module 120, the controller 100 performs various kinds of control.

The controller 100 acquires various values necessary for controlling the internal combustion engine 10. For example, the controller 100 acquires detection signals of the pressure sensors 16 and the temperature sensors 25. In addition, the controller 100 acquires detection signals of various sensors such as an accelerator operation amount sensor 200, a vehicle speed sensor 300, and an ignition sensor 400. The accelerator operation amount sensor 200 detects an accelerator operation amount that is an operation amount of an accelerator pedal operated by a user of the vehicle on which the internal combustion engine 10 is mounted. The vehicle speed sensor 300 detects a vehicle speed of the vehicle on which the internal combustion engine 10 is mounted. The controller 100 acquires, from the internal combustion engine 10, a detection signal for calculating an engine rotation speed of the internal combustion engine 10, a detection signal of an intake air amount, and the like.

### Stuck Valve Determination Process

The controller 100 outputs a valve closing signal to the shut-off valves 15, and determines whether the shut-off valves 15 are stuck open based on a decrease amount of the passage fuel pressure that occurs until an elapsed period after the valve closing signal is output reaches a predetermined specified period. The stuck open state of the shut-off valves 15 means that the shut-off valves 15 are not closed even when a valve closing signal is output to the shut-off valves 15, for example. That is, the shut-off valves 15 in the stuck open state are stuck in, for example, the open state, and thus are in the open state. During execution of the stuck valve determination process, the fuel injection valves 13 perform fuel injection. During execution of the stuck valve determination process, fuel is continuously supplied from the fuel injection valves 13 into the cylinders. The controller 100 stores, in the memory module 120, a determination result indicating that the shut-off valves 15 are stuck open when the amount of decrease in the passage fuel pressure that occurs until the elapsed time after the output of the valve closing signal reaches the predetermined specified period is smaller than a specified threshold. The specified threshold is set based on, for example, the amount of fuel consumed during the idling operation of the internal combustion engine 10. The amount of fuel consumed during the idling operation of the internal combustion engine 10 is obtained based on the number of fuel injections performed during the idling operation, the injection time, and the passage fuel temperature.

The controller 100 may set the specified threshold in accordance with the passage fuel pressure, the passage fuel temperature, and the like at the start of the stuck valve determination process. The controller 100 sets a larger specified threshold as the passage fuel temperature at the start of the stuck valve determination process is higher.

The stuck valve determination process includes a first stuck valve determination process of determining the stuck open state of the first shut-off valve 19 and a second stuck valve determination process of determining the stuck open state of the second shut-off valve 20.

First, the first stuck valve determination process will be described. During execution of the first sticking determination process, the second shut-off valve 20 is maintained in the open state.

When the first shut-off valve 19 is in the closed state, the fuel supply from the fuel tank 12 to the fuel passage 14 is stopped. When the fuel injection valves 13 inject the fuel, the fuel is supplied from the fuel injection valves 13 into the cylinder, while the fuel supply from the fuel tank 12 to the fuel passage 14 is stopped. Therefore, the first passage fuel pressure in the first pressure sensor 23 decreases. If the first shut-off valve 19 is stuck open, the supply of fuel from the fuel tank 12 to the fuel passage 14 continues, so the first passage fuel pressure does not decrease, but the amount of decrease in the first passage fuel pressure is smaller than the amount of decrease in the first passage fuel pressure when the first shut-off valve 19 is closed. Therefore, it is possible to determine that the first shut-off valve 19 is stuck open based on the amount of decrease in the first passage fuel pressure.

Next, the second stuck valve determination process will be described. During the execution of the second stuck valve determination process, the first shut-off valve 19 is preferably maintained in the closed state.

When the second shut-off valve 20 is in the closed state, the fuel supply from the fuel pipe 17 to the delivery pipe 18 is stopped. When the fuel injection valves 13 inject the fuel, the fuel is supplied from the fuel injection valves 13 into the cylinder. However, since the fuel supply from the fuel pipe 17 to the delivery pipe 18 is stopped, the second passage fuel pressure in the second pressure sensor 24 decreases. On the other hand, when the second shut-off valve 20 is stuck open, fuel continues to be supplied from the fuel pipe 17 to the delivery pipe 18, so the second passage fuel pressure does not drop. Alternatively, the amount of decrease in the second passage fuel pressure in the case in which the second shut-off valve 20 is stuck open is smaller than the amount of decrease in the second passage fuel pressure in the case in which the second shut-off valve 20 is closed. Therefore, it is possible to determine that the second shut-off valve 20 is stuck open based on the amount of decrease in the second passage fuel pressure.

### Timing at Which Stuck Valve Determination Process Is Executed

The controller 100 executes the stuck valve determination process when the internal combustion engine 10 is in the idling operation state. The idling operation state of the internal combustion engine 10 can be determined by the accelerator operation amount and the engine rotation speed. The controller 100 determines that the internal combustion engine 10 is in the idling operation state when the accelerator operation amount is 0 and the engine rotation speed of the internal combustion engine 10 is the idling rotation speed. The idling rotation speed is an engine rotation speed when the internal combustion engine 10 is in an idling operation. Here, when the engine rotation speed of the internal combustion engine 10 becomes the idling rotation speed, the engine rotation speed of the internal combustion engine 10 becomes equal to or lower than a predetermined upper limit speed and equal to or higher than a predetermined lower limit speed. The predetermined upper limit speed and the predetermined lower limit speed are set according to the fluctuation range of the engine rotation speed during the idling operation of the internal combustion engine 10. Further, the case in which the engine rotation speed of the internal combustion engine 10 becomes the idling rotation speed may include a case in which even if the engine rotation speed is higher than the idling rotation speed, the accelerator operation amount is 0, and the accelerator pedal is not operated, so that the engine rotation speed decreases to the idling rotation speed.

More preferably, the controller 100 executes the stuck valve determination process when the vehicle is in a stopped state and the internal combustion engine 10 is in the idling operation state. Whether the vehicle is in a stopped state is determined from the vehicle speed of the vehicle. That is, the stop of the vehicle, that is, the stopped state of the vehicle includes a state in which the vehicle speed is 0.

When the idling operation state of the internal combustion engine 10 ends in a case in which the elapsed time of the stuck valve determination process is less than the specified period after the start of the stuck valve determination process, the controller 100 ends the stuck valve determination process. Alternatively, when the vehicle starts traveling in a case in which the elapsed period of the stuck valve determination process is less than the specified period after the start of the stuck valve determination process, the controller 100 ends the stuck valve determination process.

When the stop operation of the internal combustion engine 10 is executed, the controller 100 stops the internal combustion engine 10 without executing the stuck valve determination process.

### Flow of Stuck Valve Determination Process

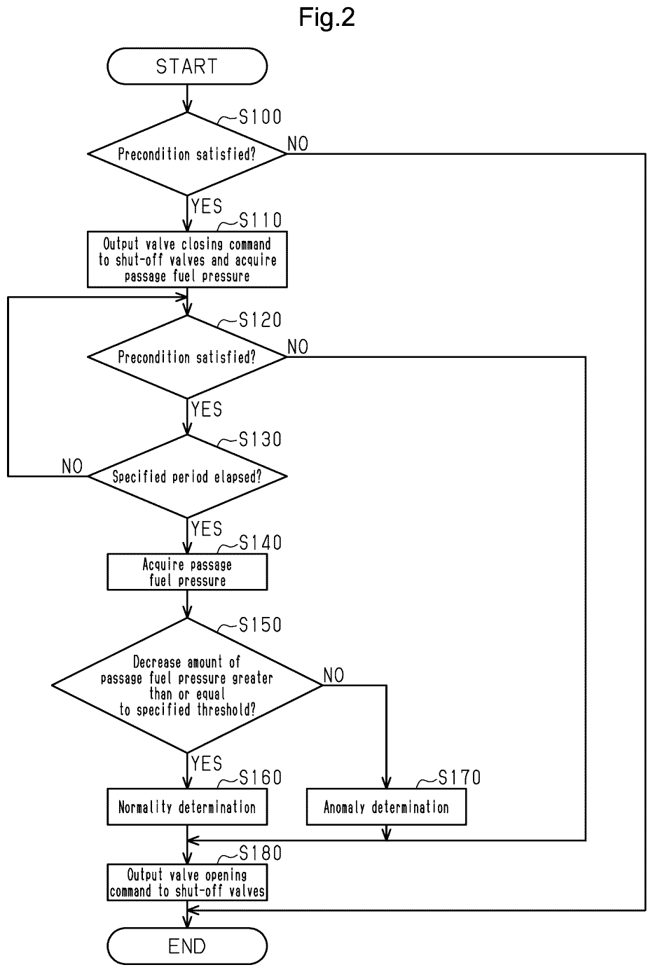

FIG. 2 shows a flow of a series of processes related to the stuck valve determination process executed by the controller 100. The controller 100 repeatedly executes the process of FIG. 2. Both the first stuck valve determination process and the second stuck valve determination process are executed in accordance with the processing procedure shown in FIG. 2. Hereinafter, a processing procedure in a case in which the first stuck valve determination process is executed as the stuck valve determination process in accordance with the processing procedure shown in FIG. 2 will be described. In the following process, the shut-off valve 15 represents the first shut-off valve 19.

The controller 100 determines whether the precondition is satisfied (S100). The precondition is a condition for determining the timing at which the stuck valve determination process is executed. The precondition includes the following conditions.

The ignition switch is on.
The internal combustion engine 10 is in an idling operation state.
The vehicle is in a stopped state.

When all of the above conditions are satisfied, the controller 100 determines that the precondition is satisfied. The controller 100 determines that the internal combustion engine 10 is in the idling operation state when the accelerator operation amount is 0 and the engine rotation speed of the internal combustion engine 10 is the idling rotation speed. The controller 100 determines whether the vehicle is in a stopped state from the vehicle speed. In addition, a condition that various sensors are normally functioning, a condition that the stuck valve determination process has not been executed even once after the internal combustion engine 10 restarts the operation after the operation is finished, or the like may be added to the precondition.

When the precondition is satisfied (S100: YES), the controller 100 outputs the valve closing command to the shut-off valves 15, acquires the passage fuel pressure (S110), and proceeds to the process of S120. When the precondition is not satisfied (S100: NO), the controller 100 ends the process of FIG. 2.

The controller 100 determines whether the precondition is satisfied (S120). That is, the controller 100 continuously determines whether the precondition is satisfied from S100. When the precondition is satisfied (S120: YES), the controller 100 proceeds to S130. When the precondition is not satisfied (S120: NO), the controller 100 proceeds to the process of S180.

The controller 100 determines whether the specified period has elapsed (S130). For example, the controller 100 determines that the specified period has elapsed when the elapsed period from the output of the valve closing command to the shut-off valves 15 in S110 is equal to or longer than the specified period. The controller 100 has a timer function for measuring the elapsed time. When the specified period has elapsed (S130: YES), the controller 100 proceeds to the process of S140. When the specified period has not elapsed (S130: NO), the controller 100 repeats the process of S120.

The controller 100 acquires the passage fuel pressure (S140) and determines whether the amount of decrease in the passage fuel pressure is equal to or greater than a specified threshold (S150). The decrease amount of the passage fuel pressure is a difference between the passage fuel pressure acquired in S110 and the passage fuel pressure acquired in S140. When the amount of decrease in the passage fuel pressure is equal to or greater than the specified threshold (S150: YES), the controller 100 stores the determination result indicating that the shut-off valves 15 are not stuck open in the memory module 120 (S160), and proceeds to the process of S180. For example, the determination result in this case indicates that the shut-off valve 15 is normal. When the decrease amount of the passage fuel pressure is less than the specified threshold (S150: NO), the controller 100 stores the determination result indicating that the shut-off valves 15 are stuck open in the memory module 120 (S170), and proceeds to the process of S180. For example, the determination result in this case indicates an abnormality of the shut-off valve 15.

After outputting the valve opening command to the shut-off valves 15 (S180), the controller 100 ends the process of FIG. 2. The controller 100 may output the determination result of the stuck open state of the shut-off valve 15 to a user of the vehicle or the like. The output of the valve opening command to the shut-off valve 15 may be executed after the passage fuel pressure is acquired after the elapse of the specified period. For example, the controller 100 may output the valve opening command to the shut-off valves 15 before S140 process is performed after S150 process is performed. In this case, the controller 100 can output the valve opening command to the shut-off valves 15 even when the precondition is not satisfied in the process of S120 (S120: NO).

When the second stuck valve determination process is executed, the second stuck valve determination process is executed in accordance with the series of processes of FIG. 2 after the first stuck valve determination process is executed as the series of processes of FIG. 2. When the second stuck valve determination process is executed following the first stuck valve determination process, the process of S180 is omitted from the series of processes of FIG. 2 in the first stuck valve determination process. In the second stuck valve determination process, after the presence or absence of the stuck open state of the shut-off valves 15 is stored in the memory module 120 (steps S160 and S170), the controller 100 outputs the valve opening command to the first shut-off valve 19 and the second shut-off valve 20 (S180).

### Flow of Stuck Valve Determination Process

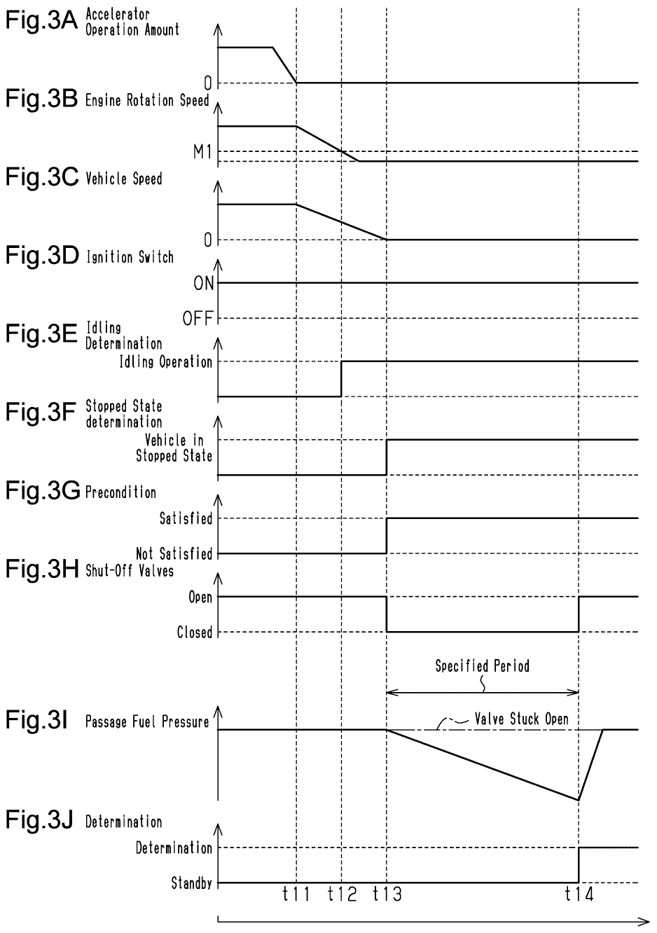

FIGS. 3A to 3J illustrate changes in the accelerator operation amount, the engine rotation speed, the passage fuel pressure, and the like during execution of the stuck valve determination process. FIGS. 3A to 3J illustrate an example in which the traveling vehicles stop.

When the user releases the accelerator pedal to stop the vehicle, the accelerator operation amount decreases as shown in FIG. 3A, and therefore, the accelerator opening is 0 at time t11. As shown in FIG. 3B, the engine speed of the internal combustion engine 10 also decreases as the accelerator operation amount decreases. Time t12 is a time at which the engine rotation speed reaches the M1 as shown in FIG. 3B. M1 indicates a predetermined upper limit speed related to the idling rotation speed. As shown in FIG. 3C, the vehicle speed also decreases from time t11. Due to the braking operation by the user of the vehicle, the vehicle speed becomes 0 km/h at time t13. As shown in FIG. 3D, the ignition switch remains on before time t11 and after time t13.

As shown in FIG. 3E, when the accelerator operation amount is 0 and the engine rotation speed is the idling rotation speed, the controller 100 determines that the internal combustion engine 10 is in the idling operation state at time t12. As shown in FIG. 3F, the controller 100 determines that the vehicle is in the stop state since the vehicle speed is 0 km/h at the point in time t13.

As shown in FIG. 3G, at time t13, the ignition switch is ON, the internal combustion engine 10 is idling, and the vehicle is in a stopped state. Thus, the precondition for the stuck valve determination process is satisfied. When the controller 100 outputs a valve closing command to the shut-off valves 15, the shut-off valves 15 are brought into a closed state as shown in FIG. 3H if the shut-off valves 15 are not stuck open.

Time t14 is a time at which a specified period has elapsed from time t13. The solid line in FIG. 3I shows the transition of the passage fuel pressure in the case in which the shut-off valves 15 are not stuck open. An alternate long and short dash line in FIG. 3I indicates a change in the passage fuel pressure when the shut-off valves 15 are stuck open. When the shut-off valves 15 are not stuck open, the passage fuel pressure continues to decrease until time t14, as indicated by the solid line. When the shut-off valve 15 is stuck open, the passage fuel pressure does not decrease as indicated by the one dot chain line. Even if the passage fuel pressure decreases, the amount of decrease in the passage fuel pressure is smaller than the amount of decrease in the passage fuel pressure in the case in which the stuck open state has not occurred.

As shown in FIG. 3J, the controller 100 determines whether the shut-off valves 15 are normal or abnormal with respect to the stuck open state based on the decrease amount of the passage fuel pressure at time t14. Further, the controller 100 outputs a valve opening command to the shut-off valve 15.

### Operation and Advantages of Present Embodiment

(1) The stuck valve determination process involves the closing operation of the shut-off valve 15. The closing operation of the shut-off valve 15 includes driving the shut-off valve 15 to close the shut-off valve 15. Therefore, the fuel supplied to the internal combustion engine 10 is limited during execution of the stuck valve determination process. When the fuel supplied to the internal combustion engine 10 is limited, the vehicle traveling may be affected. For example, when the stuck valve determination process is executed in a case in which the engine rotation speed of the internal combustion engine 10 is higher than the idling rotation speed, the amount of fuel in the portion between the shut-off valve 15 and the fuel injection valves 13 rapidly decreases. In this case, the internal combustion engine 10 can be stopped. On the other hand, the controller 100 of the present embodiment executes the stuck valve determination process when the internal combustion engine 10 enters the idling operation state. Since the stuck valve determination process is executed when the internal combustion engine 10 is in the idling operation state, an unintended stop of the internal combustion engine 10 can be avoided. That is, the controller 100 can execute the stuck valve determination process when the influence on the vehicle traveling is small.
(2) When the vehicle is stopped by a braking operation performed by the user, the internal combustion engine 10 shifts to the idling operation state before the vehicle stops. The possibility that the accelerator pedal is depressed immediately after the vehicle is stopped is lower than the possibility that the accelerator pedal is depressed immediately after the internal combustion engine 10 is shifted to the idling operation state while the vehicle is traveling. During execution of the stuck valve determination process, the passage fuel pressure decreases. If the accelerator pedal is depressed during execution of the stuck valve determination process, the vehicle acceleration performance may decrease if the fuel injection valves 13 cannot inject the amount of fuel required for vehicle acceleration. On the other hand, the controller 100 of the present embodiment starts the stuck valve determination process when the vehicle is stopped. Therefore, there is a high possibility that the stuck valve determination process is completed before the accelerator pedal is depressed. Therefore, deterioration of the vehicle acceleration performance can be suppressed.

### Modifications

The above-described embodiment may be modified as follows. The above-described embodiment and the following modifications can be combined as long as the combined modifications remain technically consistent with each other.

The internal combustion engine 10 may be configured to include only one of the first shut-off valve 19 and the second shut-off valve 20 as the shut-off valve.

When the controller 100 executes the stuck valve determination process, only one of the first stuck valve determination process and the second stuck valve determination process may be executed as the stuck valve determination process.

When the internal combustion engine 10 is in the idling operation state, the controller 100 may execute the stuck valve determination process during the vehicle traveling. For example, when the stuck valve determination process is executed during a period from when the user performs a brake operation to when the vehicle is completely stopped, the stuck valve determination process is started early.

The controller 100 may determine that the internal combustion engine 10 is in the idling operation state regardless of the accelerator operation amount when the engine rotation speed of the internal combustion engine 10 becomes the idling rotation speed.

The controller 100 may execute the stuck valve determination process not only when the internal combustion engine 10 enters the idling operation state, but also when the stop operation of the internal combustion engine 10 is executed.

The controller 100 is not limited to a device that includes a CPU and a memory module and executes software processing. For example, the controller 100 may include hardware circuits, for example, an application-specific integrated circuit (ASIC)), dedicated to executing at least part of the processes executed by the software in the above-described embodiment. That is, the controller 100 may be modified as long as it includes processing circuitry that has any one of the following configurations (a) to (c). (a) Processing circuitry including one or more processors that execute all of the above-described processes according to programs and one or more program storage devices such as ROMs that store the programs. (b) Processing circuitry including one or more processors and one or more program storage devices that execute part of the above-described processes according to the programs and one or more dedicated hardware circuits that execute the remaining processes. (c) Processing circuitry including one or more dedicated hardware circuits that execute all of the above-described processes. The program storage devices, which are computer-readable media, include any type of medium that is accessible by a general-purpose computer or a dedicated computer.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller for an internal combustion engine, the controller comprising control circuitry, wherein
the control circuitry is configured to execute a determination process when the internal combustion engine is in an idling operation state,
the internal combustion engine is mounted on a vehicle,
the internal combustion engine includes:
a fuel tank storing gaseous fuel;
a fuel injection valve supplying the gaseous fuel into a cylinder;
a fuel passage connecting the fuel tank to the fuel injection valve;
a shut-off valve disposed in the fuel passage; and
a pressure sensor disposed in a portion of the fuel passage between the shut-off valve and the fuel injection valve,
the pressure sensor detects a passage fuel pressure that is a pressure of the gaseous fuel in a portion of the fuel passage between the shut-off valve and the fuel injection valve, and
the determination process determines whether the shut-off valve is stuck open based on an output of a valve closing signal to the shut-off valve and a decrease amount of the passage fuel pressure that occurs until an elapsed period after the valve closing signal is output reaches a predetermined specified period.

2. The controller for the internal combustion engine according to claim 1, wherein the control circuitry is configured to execute the determination process when the vehicle is in a stopped state and the internal combustion engine is in an idling operation state.

3. An internal combustion engine mounted on a vehicle, the internal combustion engine comprising:
a fuel tank storing gaseous fuel;
a fuel injection valve supplying the gaseous fuel into a cylinder;
a fuel passage connecting the fuel tank to the fuel injection valve;
a shut-off valve disposed in the fuel passage;
a pressure sensor disposed in a portion of the fuel passage between the shut-off valve and the fuel injection valve, the pressure sensor detecting a passage fuel pressure that is a pressure of the gaseous fuel in the portion of the fuel passage between the shut-off valve and the fuel injection valve; and
a controller including control circuitry, the control circuitry being configured to execute a determination process when the internal combustion engine is in an idling operation state, and the determination process determining whether the shut-off valve is stuck open based on an output of a valve closing signal to the shut-off valve and a decrease amount of the passage fuel pressure that occurs until an elapsed period after the valve closing signal is output reaches a predetermined specified period.
